(19) United States
(12) Patent Application Publication
(10) Pub. No.: US 2018/0070397 A1
(43) Pub. Date: Mar. 8, 2018

(54) TETHERED DEVICE SWITCH WITH WIRELESS CONNECTION

(71) Applicant: Pervacio Inc., Irving, TX (US)

(72) Inventors: Sanjay Kanodia, Irving, TX (US); Mika Löyttyniemi, Lieto (FI); Vasily Balagurov, Salo (FI)

(21) Appl. No.: 15/674,445

(22) Filed: Aug. 10, 2017

Related U.S. Application Data
(60) Provisional application No. 62/373,173, filed on Aug. 10, 2016.

(51) Int. Cl. H04W 76/02; H04L 29/08

(52) U.S. Cl. CPC H04W 76/023; H04L 67/36; H04L 67/06

(57) ABSTRACT

A method for rapid transfer of content files from a source to a target includes with a controller module, exchanging wireless connectivity credentials between the source and the target through a controller over a wired connection; transferring, over the wired connection, the content files from the source, through the controller to the target over the wired connection. With a source switch module, a wireless connection is established between the source and the target with the exchanged wireless connectivity credentials and content files are transferred to the target directly over the wireless connection. The content files are received at the target from the source directly over the wireless connection.

### SUMMARY

It is an object of the disclosure to provide a system for rapid transfer of content files from a source to a target. The system includes a controller module, a target switch module and a source switch module. The source switch module is configured to transmit wireless connectivity credentials to the target through a controller over a wired connection, receive wireless connectivity credentials from the target through the controller over the wired connection, transfer the content files through the controller to the target over the wired connection; and establish a direct wireless connection with the target using the exchanged wireless connectivity credentials; and transfer files to the target over the direct wireless connection.

It is another object of the disclosure to provide a method for rapid transfer of content files from a source to a target. The method includes transmitting wireless connectivity credentials to the target through a controller over a wired connection, receiving wireless connectivity credentials from the target through the controller over the wired connection, transferring the content files through the controller to the target over the wired connection, establishing a direct wireless connection with the target with the exchanged wireless connectivity credentials and transferring the content files to the target over the direct wireless connection.

It is another object of the disclosure to provide a non-transitory computer-readable medium having stored thereon computer readable instructions. The computer readable instructions are configured to cause one or more computers to transmit wireless connectivity credentials to the target through a controller over a wired connection, receive wireless connectivity credentials from the target through the controller over the wired connection, transfer the content files through the controller to the target over the wired connection, establish a direct wireless connection with the target with the exchanged wireless connectivity credentials and transfer the content files to the target over the direct wireless connection.

It is yet another object of the disclosure to provide a system for rapid transfer of content files from a source to a target. The system includes a controller module, a source switch module and a target switch module. The controller module is configured to exchange wireless connectivity credentials with the source over a wired connection, exchange wireless connectivity credentials with the target over a wired connection, establish a wireless connection between the source and a controller using the exchanged wireless connectivity credentials, establish a wireless connection between the target and the controller using the exchanged wireless connectivity credentials, transfer, over the wired connection, the content files from the source, through the controller to the target. The source switch module configured to transfer, over the wireless connection using the exchanged wireless connectivity credentials, the content files from the source, to the control machine. The target switch module configured to receive files at the target through the controller over the wireless connection.

### BRIEF DESCRIPTION OF THE FIGURES

The following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 schematically illustrates an example network environment suitable for use with embodiments of the present disclosure.

FIG. 2 schematically illustrates an example source user device suitable for use with embodiments of the disclosure.

FIG. 3 schematically illustrates an example target user device suitable for use with embodiments of the disclosure.

FIG. 4 schematically illustrates an example controller device suitable for use with embodiments of the disclosure.

FIG. 5 schematically illustrates an example system suitable for practicing embodiments of the present disclosure.

FIGS. 6A-6C illustrate an example method of rapid content transfer in accordance with an embodiment of the present disclosure.

FIG. 7 schematically illustrates a second example system suitable for practicing embodiments of the present disclosure.

FIGS. 8A-8C illustrate a second example method of rapid content transfer in accordance with an embodiment of the present disclosure.

FIG. 9 schematically illustrates a third example system suitable for practicing embodiments of the present disclosure.

FIGS. 10A-10C illustrate a third example method of rapid content transfer in accordance with an embodiment of the present disclosure.

FIG. 11 illustrates an example user interface which may be presented to a display of a controller device, a source user device, a target user device or any combination of these.

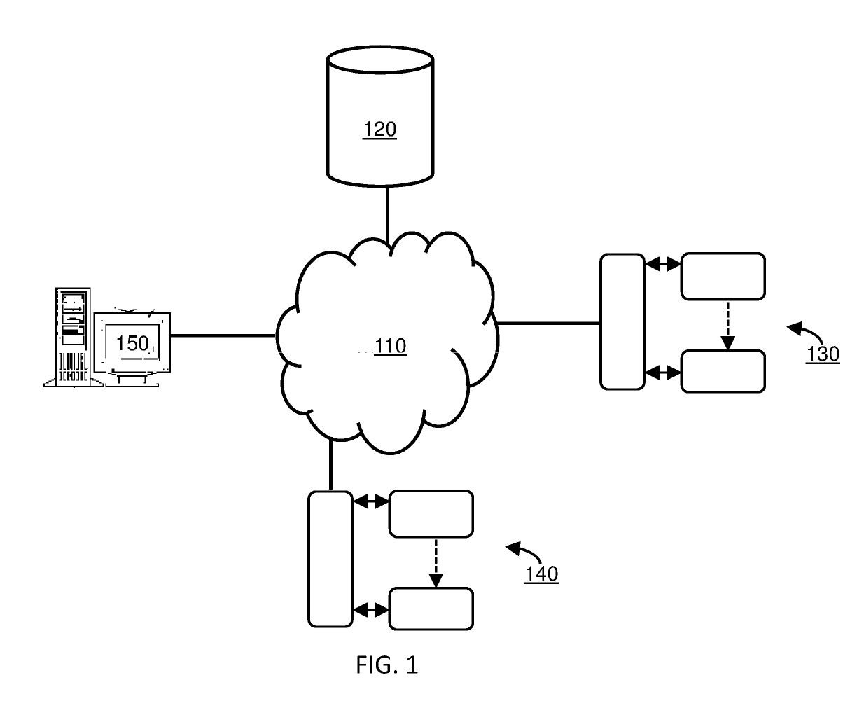

### DETAILED DESCRIPTION

The following detailed description illustrates embodiments of the present disclosure and manners by which they may be implemented. Although the best mode of carrying out the present disclosure has been disclosed, those skilled in the art would recognize that other embodiments for carrying out or practicing the disclosed systems and methods are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

Because mobile device users store all of their personal files, including pictures and videos on their mobile devices, the file size of content on mobile devices has been consistently increasing. When a user chooses to change devices, for example in an upgrade, inefficiencies of content transfer between the user's old device and his/her new device can cause the retailer unnecessarily high overhead. A typical content transfer can frequently last 10, 20, 30 minutes or more.

Embodiments of the present disclosure provide methods and systems for rapid transfer of content files from a first mobile device to a second mobile device. Some aspects of the method may be computer-implemented.

Embodiments of the present disclosure substantially reduce content transfer times by combining wired and wireless connections between an old device (source) and the new device (target). In some examples, content transfer times can be reduced by 50%. For example, transfer times may be reduced to 5, 10 or 15 minutes.

Additional aspects, advantages, features and objects of the present disclosure will be made apparent from the drawings and the detailed description of the illustrative embodiments construed in conjunction with the appended claims that follow.

It will be appreciated that disclosed features are susceptible to being combined in various combinations without departing from the scope of the disclosure as defined by the appended claims.

Embodiments of the present disclosure may employ one or more networks provided as part of a network environment. The network environment may include one or more data processing units or computing devices 130 and 140. The network environment may also include a server 150, a database 120, and a communication network 110.

The network environment may be implemented in various ways, depending on various possible scenarios. In one example scenario, the network environment may be implemented by way of a spatially collocated arrangement of server 150 and database 120. In another example scenario, the network environment may be implemented by way of a spatially distributed arrangement of server 150 and database 120 coupled mutually in communication via communication network 110. In yet another example scenario, server 150 and database 120 may be implemented via cloud computing services.

Data processing units 130 and/or 140 may be coupled in communication with server 150 via communication network 110. Communication network 110 can be a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAX) networks.

Examples of the data processing units 130 and 140 contributing to the network include, but are not limited to, mobile phones, smart telephones, Mobile Internet Devices (MIDs), tablet computers, Ultra-Mobile Personal Computers (UMPCs), phablet computers, Personal Digital Assistants (PDAs), web pads, Personal Computers (PCs), handheld PCs, laptop computers, desktop computers, Network-Attached Storage (NAS) devices, large-sized touch screens with embedded PCs, and interactive entertainment devices, such as game consoles, Television (TV) sets and Set-Top Boxes (STBs).

The network environment is suitable for implementing various systems for transferring content. In order to implement a system for content transfer, server 150 may provide a content transfer service to the data processing units, and store data related to the content transfers. Accordingly, the system can be implemented by way of at least one of: a hardware system, a software system or a combination of these.

Optionally, data processing units 130 and/or 140 may access server 150 to download one or more software products associated with the content transfer service. In one embodiment, the system is arranged in a manner that its functionality is implemented partly in the data processing units 130 and 140 and partly in the server.

In another embodiment, the system is arranged in a manner such that its functionality is implemented substantially in data processing units 130 and/Or 140 by way of the downloaded software products. In such a situation, the data processing units 130 and/or 140 may be coupled to server 150 periodically or randomly from time to time, for example, to receive updates from and/or to upload status to server 150.

Users associated with data processing units 130 and/or 140 use the content transfer service. Accordingly, some of data processing units 130 and/or 140 may be used, operated, or carried by mobile device users, while some of the data processing units may be used, operated, or carried by retail or service personnel for supporting content transfer between user mobile devices.

In an embodiment of the present disclosure, data processing units 130 and/or 140 and/or server 150 substantially continuously record and update changes in the status of the content transfers in a database known as a content list. The content list may be stored locally or remotely, for example, at database 120.

The content transfer service can be offered free of cost as part of a new equipment purchase or trade-in. Alternatively, the content transfer service can be a paid service that has a subscription-based billing or a transaction-based billing, such as pay-per-use and pay-per-feature.

The above are merely examples, which should not unduly limit the scope of the claims herein. It is to be understood that any specific designation for a network environment is provided as an example and is not to be construed as limiting the network environment to specific numbers, types, or arrangements of data processing units, servers, databases and communication networks. A person skilled in the art will recognize many variations, alternatives, and modifications of embodiments of the present disclosure.

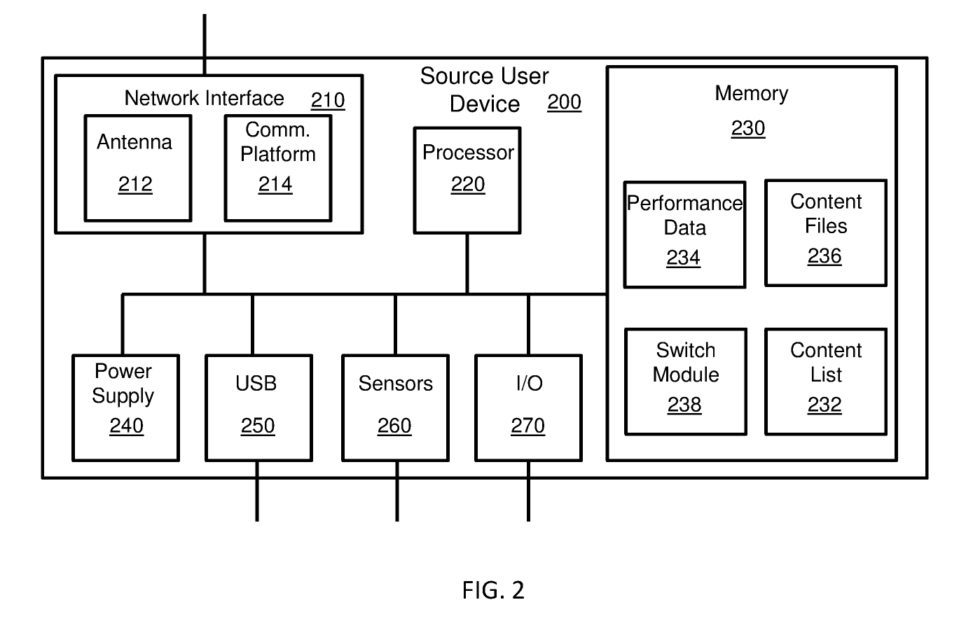

FIG. 2 is a schematic illustration of various components of a source user device 200. Source user device 200 may include, but is not limited to, a memory 230, a computing hardware such as a processor 220, USB input/output 250, a general I/O 270, a network interface 210, a configuration of sensors 260, and a system bus that operatively couples various components including the memory 230, the processor 220, the USB input/output 250, I/O 270, the network interface 210, and the sensors 260. The I/O may be configured for presenting graphical images to a display of the source user device.

The source user device may also include a power source 240 for supplying electrical power to the various components of the source user device. The power source 240 may, for example, include a rechargeable battery.

The memory 230 optionally includes non-removable memory, removable memory, or a combination thereof. The non-removable memory, for example, includes Random-Access Memory (RAM), Read-Only Memory (ROM), flash memory, or a hard drive. The removable memory, for example, includes flash memory cards, memory sticks, or smart cards.

The memory 230 may be configured to store, for example, data 234 reflecting performance of the disclosed transfer systems and methods, content files 236 to be transferred, a source switch module 238 and/or a content list 232. Source switch module 238 and content list 232 may, for example, be parts of a software product associated with the rapid content transfer service. Executing the software product on processor 220 results in connectivity and content management and may also generate and render a graphical user interface on a display screen. The graphical user interface may be configured to facilitate user interactions with the rapid content transfer service.

In some examples, a display screen may be a touch-sensitive display screen that is operable to receive tactile inputs from the user. These tactile inputs may, for example, include clicking, tapping, pointing, moving, pressing and/or swiping with a finger or a touch-sensitive object like a pen.

Additionally or alternatively, I/O 270 for the source user device may include a mouse or a joystick that is operable to receive inputs corresponding to clicking, pointing, and/or moving a pointer object on the graphical user interface. I/O 270 may also include a keyboard that is operable to receive inputs corresponding to pushing certain buttons on the keyboard.

Additionally, I/O 270 may also include a microphone for receiving an audio input from the user, and a speaker for providing an audio output to the user.

Moreover, sensors 260 may include one or more of: an accelerometer, a magnetometer, a pressure sensor, a temperature sensor, a gyroscopic sensor, a Global Positioning System (GPS) sensor, or a timer. Sensors 260 may be used to measure and collect data related to surroundings of the user. Additionally, outputs generated by sensors 260 may, for example, be indicative of the transfer rate, the strength of a wireless connection, transfer status, etc.

In some examples, a software product may be interfaced with sensors 260. When executed on processor 220, the software product is configured to resolve and integrate the outputs of sensors 260 into useful information about transfer rate, the strength of a wireless connection, transfer status, etc.

In some examples, sensors 260 may include a timer for including the time-stamps in the content list and/or performance data 234.

Moreover, memory 230 is a non-transient data storage media. Software products, when executed on processor 220, are optionally coupled to data storage 232, and configured to substantially continuously record and update transfer status with performance data 234 in memory 230 and/or in content list 232.

Furthermore, network interface 210 optionally allows the source user device to connect to a communication network and/or target user devices and/or controller devices. Additionally, network interface 210 may allow the source user device to access a server to update one or more software products and/or download one or more new software products associated with the content transfer service.

Moreover, network interface 210 optionally allows the source user device to communicate with other data processing units, for example, via communication network 210.

The source user device is optionally implemented by way of at least one of: a mobile phone, a smart telephone, an MID, a tablet computer, a UMPC, a phablet computer, a PDA, a web pad, and a handheld PC.

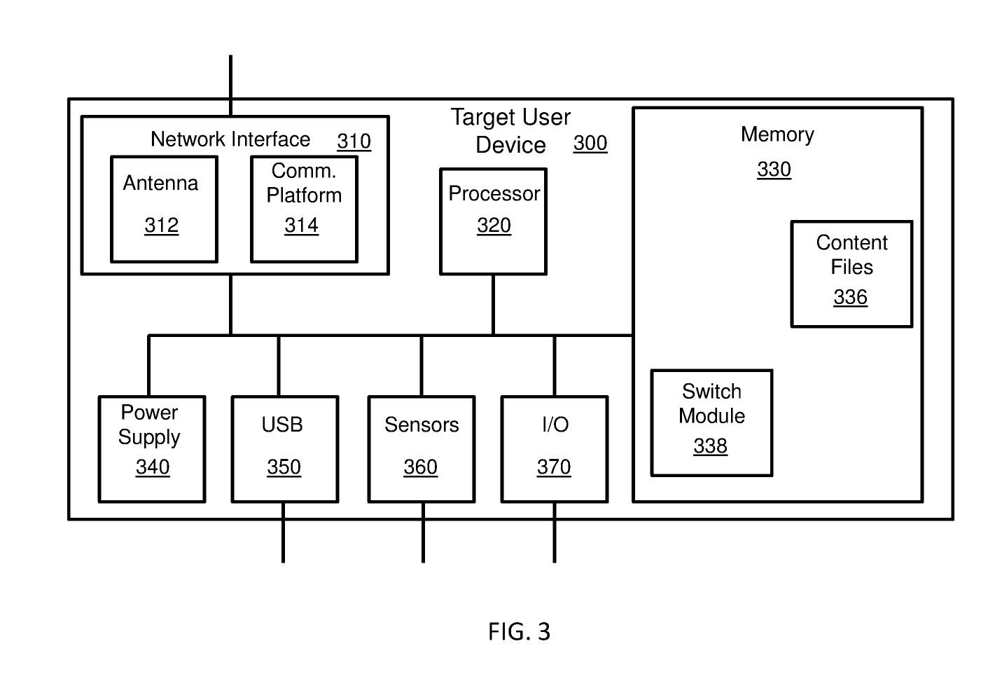

FIG. 3 is a schematic illustration of various components of a target user device 300. The target user device 300 may include, but is not limited to, a memory 330, a computing hardware such as a processor 320, USB input/output 350, a general I/O 370, a network interface 310, a configuration of sensors 360, and a system bus that operatively couples various components including the memory 330, the processor 320, the USB input/output 350, I/O 370, the network interface 310 and sensors 360. I/O 370 may be configured for presenting graphical images to a display of target user device 300.

Target user device 300 may also include a power source 340 for supplying electrical power to the various components of the target user device. Power source may 340, for example, include a rechargeable battery.

Memory 330 optionally includes non-removable memory, removable memory, or a combination thereof. The non-removable memory, for example, includes Random-Access Memory (RAM), Read-Only Memory (ROM), flash memory, or a hard drive. The removable memory, for example, includes flash memory cards, memory sticks, or smart cards.

Memory 330 may be configured to store, for example, content files 336 which have been transferred from a source user device and a device switch module 338 which may, for example, be part of a software product associated with the rapid content transfer service. Memory 330 is non-transient data storage media and executing the software product on processor 320 results in connectivity and content management and may also generate and render a graphical user interface on a display screen. The graphical user interface may be configured to facilitate user interactions with the rapid content transfer service. In some examples, memory 330 stores data reflecting performance of the disclosed transfer systems and methods.

In some examples, the display screen may be a touch-sensitive display screen that is operable to receive tactile inputs from the user. These tactile inputs may, for example, include clicking, tapping, pointing, moving, pressing and/or swiping with a finger or a touch-sensitive object like a pen.

Additionally or alternatively, I/O 370 for the target user device may include a mouse or a joystick that is operable to receive inputs corresponding to clicking, pointing, and/or moving a pointer object on the graphical user interface. I/O 370 may also include a keyboard that is operable to receive inputs corresponding to pushing certain buttons on the keyboard.

Additionally, I/O 370 may also include a microphone for receiving an audio input from the user, and a speaker for providing an audio output to the user.

Moreover, sensors 360 may include one or more of: an accelerometer, a magnetometer, a pressure sensor, a temperature sensor, a gyroscopic sensor, a Global Positioning System (GPS) sensor, or a timer. Sensors 360 may be used to measure and collect data related to surroundings of the user. Additionally, outputs generated by sensors 360 may, for example, be indicative of the transfer rate, the strength of a wireless connection, transfer status, etc.

In some examples, a software product may be interfaced with sensors 360. When executed on a processor, the software product is configured to resolve and integrate the outputs of sensors 360 into useful information about transfer rate, the strength of a wireless connection, transfer status, etc.

In some examples, sensors 360 may include a timer for including the time-stamps with content list 332 and/or performance data.

Furthermore, network interface 310 optionally allows target user device 300 to connect to a communication network and/or source user devices and/or controller devices. Additionally, network interface 310 may allow the target user device to access a server to update one or more software products and/or download one or more new software products associated with the content transfer service.

Moreover, network interface 310 optionally allows the target user device to communicate with other data processing units, for example, via communication network 310.

Target user device 300 is optionally implemented by way of at least one of: a mobile phone, a smart telephone, an MID, a tablet computer, a UMPC, a phablet computer, a PDA, a web pad, and a handheld PC.

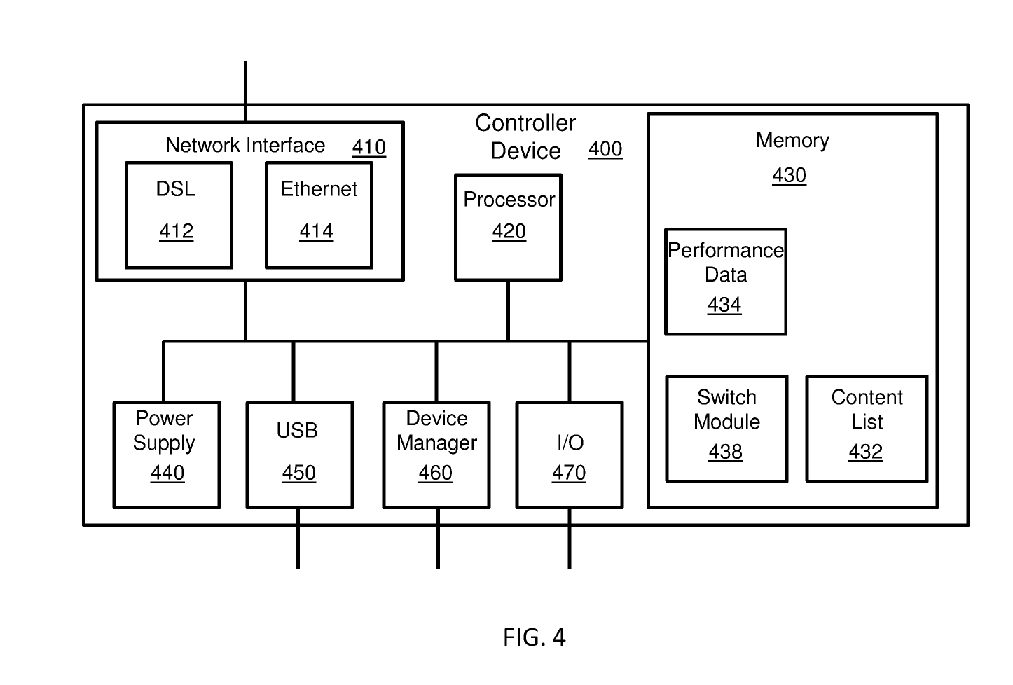

FIG. 4 is a schematic illustration of various components of a controller device 400. Controller device 400 (which may also be referred to as a control machine) may include, but is not limited to, a memory 430, a computing hardware such as a processor 420, USB input/output 450, I/O 470, a network interface 410, a device manager 460, a data storage 432, and a system bus that operatively couples various components including memory 430, processor 420, USB input/output 450, a general I/O 470, network interface 410, and device manager 460. I/O 470 may be configured for presenting graphical images to a display of controller device 400.

Controller device 400 may also include a power source 440 for supplying electrical power to the various components of the controller device. The power source 440 may, for example, include a rechargeable battery.

Memory 430 optionally includes non-removable memory, removable memory, or a combination thereof. The non-removable memory, for example, includes Random-Access Memory (RAM), Read-Only Memory (ROM), flash memory, or a hard drive. The removable memory, for example, includes flash memory cards, memory sticks, or smart cards. Moreover, memory 440 is a non-transient data storage media.

Memory 430 may be configured to store, for example, data 434 reflecting performance of the disclosed transfer systems and methods as well as a controller switch module 438, content files 436 associated with controller device 400 and a content list 432 which may, for example, be parts of a software product associated with the rapid content transfer service. Executing the software product on processor 420 results in connectivity and content management and is configured to substantially continuously record and update transfer status with performance data 434 and/or in content list 432. In some examples, content list 432 may be eliminated and tasks related thereto are managed by one or more software products installed to a source user device.

The software product stored to memory 430, when executed on processor 420, may also generate and render a graphical user interface on a display screen. The graphical user interface may be configured to facilitate user interactions with the rapid content transfer service.

In some examples, the display screen may be a touch-sensitive display screen that is operable to receive tactile inputs from the user. These tactile inputs may, for example, include clicking, tapping, pointing, moving, pressing and/or swiping with a finger or a touch-sensitive object like a pen.

Additionally or alternatively, I/O 470 for controller device 400 may include a mouse or a joystick that is operable to receive inputs corresponding to clicking, pointing, and/or moving a pointer object on the graphical user interface. The I/O 470 may also include a keyboard that is operable to receive inputs corresponding to pushing certain buttons on the keyboard.

Additionally, I/O 470 may also include a microphone for receiving an audio input from the user, and a speaker for providing an audio output to the user.

In an example, controller device 400 may include one or more sensors (not illustrated) configured to output information indicative of the transfer rate, the strength of a wireless connection, transfer status, etc.

Furthermore, network interface 410 optionally allows controller device 400 to connect to a communication network and/or target user devices and/or source user devices. Additionally, network interface 410 may allow controller device 400 to access a server to update one or more software products and/or download one or more new software products associated with the content transfer service.

Moreover, network interface 410 optionally allows the controller device to communicate with other data processing units, for example, via communication network 410.

Controller device 400 is optionally implemented by way of at least one of: a PC, a handheld PC, a laptop computer, a desktop computer, an NAS device, a large-sized touch screen with an embedded PC, and an interactive entertainment device, such as a game console, a TV set and an STB.

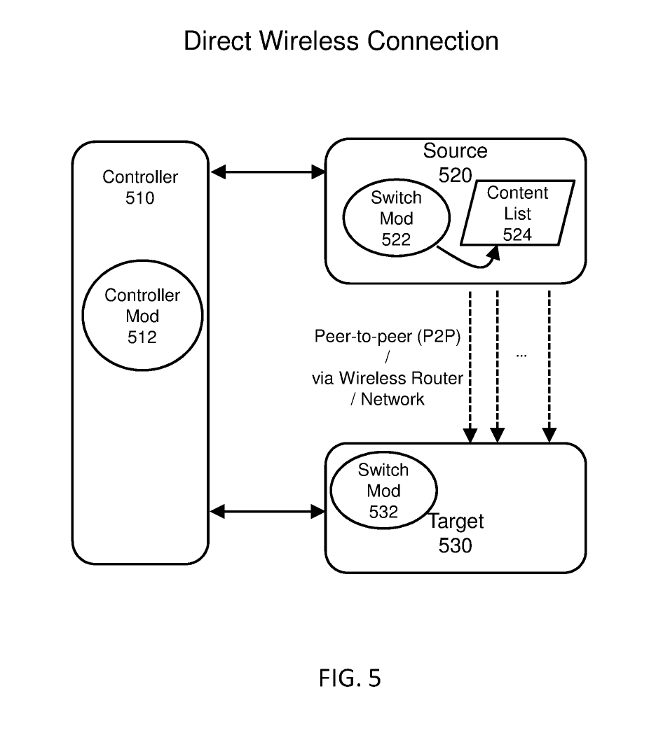

Referring to FIG. 5, according to a first example embodiment, a system for rapid transfer of content files from a source user device 520 to a target user device 530, includes a controller module 512 employed by or installed to a controller device 510, a source switch module 522 employed by or installed to a source user device 520 and a target switch module 532 employed by or installed to a target data user device 530. In FIG. 5, solid-line arrows reflect wired connections while broken-line arrows reflect wireless connections.

An example controller module 520 is configured to establish a wired connection with the source user device 520 and with the target user device 530. In an example, controller module 512 establishes a wired connection with each of the source user device 520 and the target user device 530 by way of a universal serial bus (USB) and drivers configured to support the USB. Controller module 512 may also provide a source switch module 522 to source user device 520, for example, by download over the wired connection. The controller may further provide a target switch module 532 to target user device 530, for example, by download over the wired connection. Controller module 512 is also configured to share or exchange wireless connectivity credentials between source 520 and the target user device 530 over the wired connection. Wireless connectivity credentials may include but are not limited to network ID, security methods used and password(s). Controller module 512 is further configured to transfer content files (for example content files 236 of FIG. 2) from source user device 520 the target 530 over the wired connection. Any data or content transmitted over the wired connection may be transmitted through the controller or, in an example, may be transmitted in such a way as to bypass the controller or active components thereof.

An example source switch module 522 may be configured to establish the wired connection with the controller 510 in cooperation with controller module 512. In one example, source switch module 522 takes a passive role in establishing the wired connection while, in another example, the source switch module 522 takes a more active role. Source switch module 522 is further configured to, over the wired connection, transmit wireless connectivity credentials to the target through a controller over a wired connection and receive wireless connectivity credentials from the target through the controller over the wired connection.

share wireless connectivity credentials with the target user device 530. Using the shared wireless connectivity credentials, source user device 520 establishes a direct wireless connection with target user device 530 and creates a content list 524 reflecting content file identities and corresponding transfer status. Source user device 520 transfers content files to the target user device 530 through the controller 510 over the wired connection, transfers content files to the target user device 530 directly over the wireless connection and updates content list 524. Example content files include image files, video files, audio files, text files, contacts, settings.

Transferring content files from source user device 520 to target user device 530 over the wireless connection is performed while transferring content files from source user device 520 through the controller device 510 to the target user device 530 over the wired connection.

In an example, source switch module 522 is configured to store data pertaining to content transfer and performance thereof (see, for example, performance data 234, FIG. 2). For example, data descriptive of one or more of transfer speed, transfer integrity, transfer confidentiality and transfer authenticity may be collected and stored by the source user device 520 either locally or in a database with which the source user device 520 is communicatively coupled.

Source user device 520 manages transfer policy in accordance with file identities and corresponding transfer status. For example, source switch module 522 is further configured to route content files to the wireless connection or the wired connection in accordance with data pertaining to the performance of content transfers by each of the wireless connection and the wired connection. As such, content files may be routed to the wireless connection when the wireless connection is performing better than the wired connection or to the wired connection when the wired connection is performing better than the wireless connection.

Source switch module 522 may be further configured to present a user interface to a display. The user interface may include, but is not limited to including icons/features representative of transfer process status and controls buttons, knobs, sliders, etc., for managing the transfer process.

An example target switch module 532 is configured to establish the wired connection with controller device 510 (control machine). Over the wired connection, wireless connectivity credentials are shared with source user device 520. Using the shared wireless connectivity credentials, the wireless connection is established with source user device 520. Target switch module 532 may additionally be configured to receive files from source user device 520 through controller device 510 over the wired connection while receiving content files at target user device 530 from source user device 520 directly over the wireless connection.

In some examples, source switch module 522 and target switch module 532 can be instances of the same module. Furthermore, features, responsibilities and/or capabilities of one of controller module 512 and switch modules 522 or 532 can be exchanged between the modules.

FIG. 5 is merely an example, which should not unduly limit the scope of the claims herein. It is to be understood that the specific designation for the source and target data processing units is provided as an example and is not to be construed as limiting the data processing units to specific numbers, types, or arrangements of modules and/or components of the data processing units. Furthermore, the specific designation for the controller is provided as an example and is not to be construed as limiting the controller to specific numbers, types, or arrangements of modules and/or components. A person skilled in the art will recognize many variations, alternatives, and modifications of embodiments of the present disclosure.

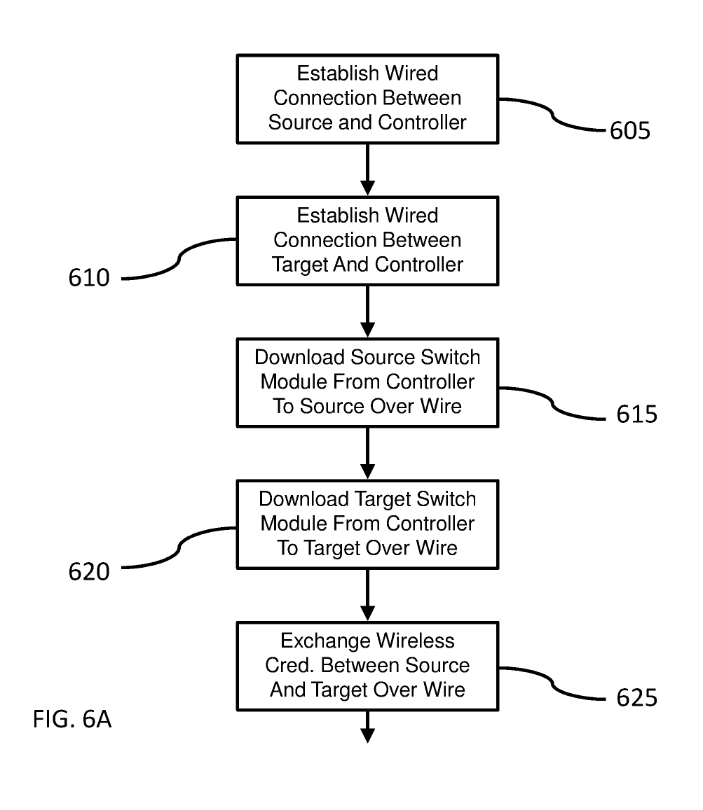

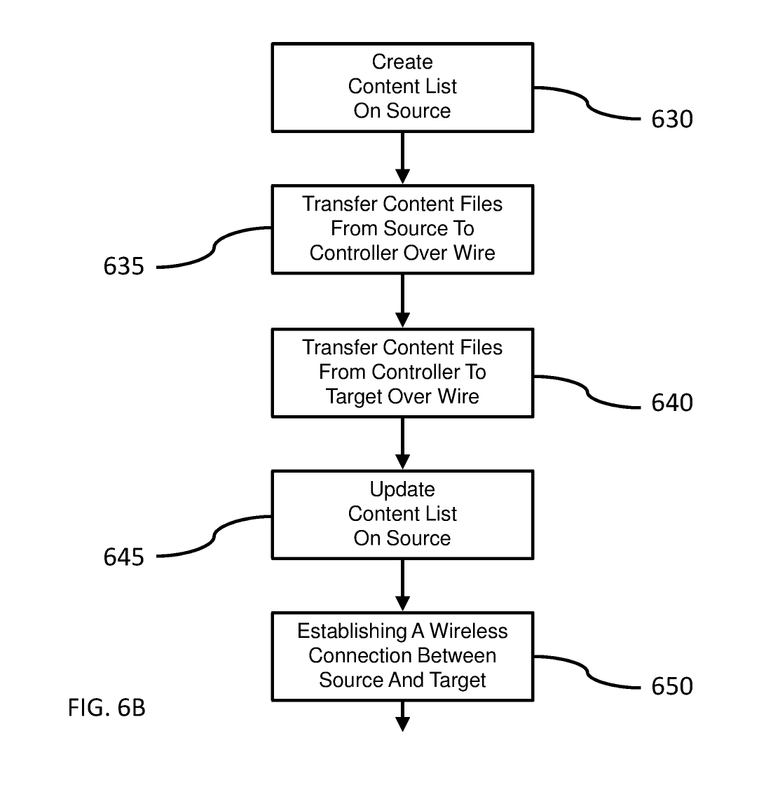

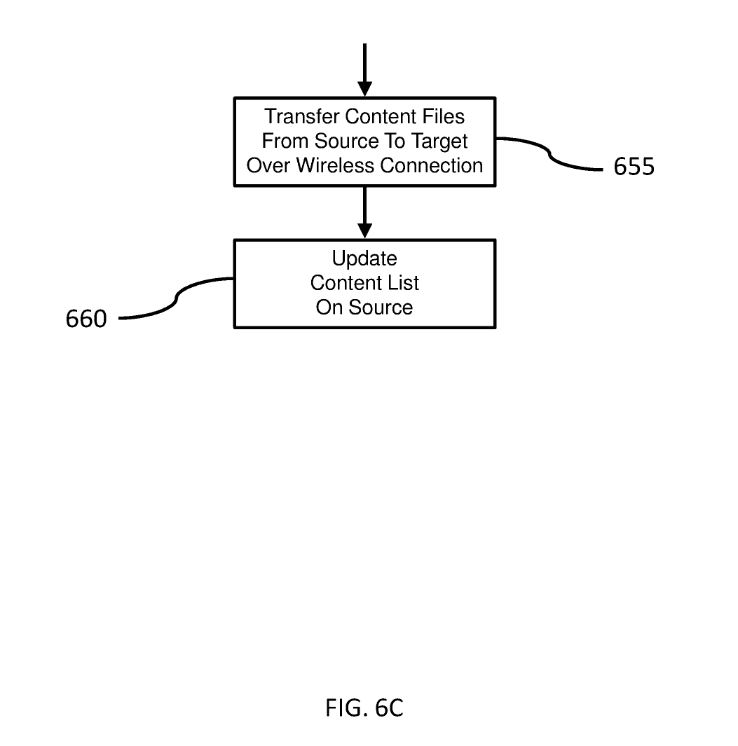

FIGS. 6A-6C illustrate actions of an example method for rapid content transfer from a source to a target, in accordance with an embodiment of the present disclosure. The method is depicted as a collection of actions in a logical flow diagram, which represents an example sequence of actions that may be implemented in hardware, software, or a combination thereof, as depicted by way of example in FIG. 5.

A wired connection is established between the source user device and a controller at 605 and between the target user device and the controller at 610. Over the wired connection, a source switch module is downloaded from the controller to the source user device at 615 and a target switch module is downloaded from the controller to the target user device at 620. Wireless connectivity credentials are exchanged or otherwise shared between the source and the target user device through the controller over the wired connection at 625. Wireless connectivity credentials are transmitted to the target through a controller over a wired connection and received from the target user device by the source user device through the controller over the wired connection at 625. At 630, a content list is created at the source user device reflecting details of the content files including identities, file sizes and types and corresponding transfer status. The content files are transferred from the source user device, through the controller to the target user device over the wired connection at 640 and the content list is updated with content file transfer status at 645.

With the shared wireless connectivity credentials, the wireless connection is established directly between the source user device and the target user device at 650. Content files are transferred to the target user device directly over the wireless connection at 655 and data pertaining to the performance of content transfers is collected and stored at 660 either locally or remotely. In an example, performance data in addition to other information may be stored as part of the content list.

Transfer policy is managed in accordance with file identities, corresponding transfer status and transfer performance data. For example, content files may be routed to the wireless connection or the wired connection in accordance with data pertaining to the performance of content transfers by each of the wireless connection and the wired connection.

Transferring the content files to the target user device over the direct wireless connection is performed while transferring the content files from the source user device, through the controller to the target user device over the wired connection.

A user interface may be presented to a display as part of the content transfer method. In an example, the user interface comprises icons/features representative of transfer process status. In a further example, the user interface comprises controls for the transfer process.

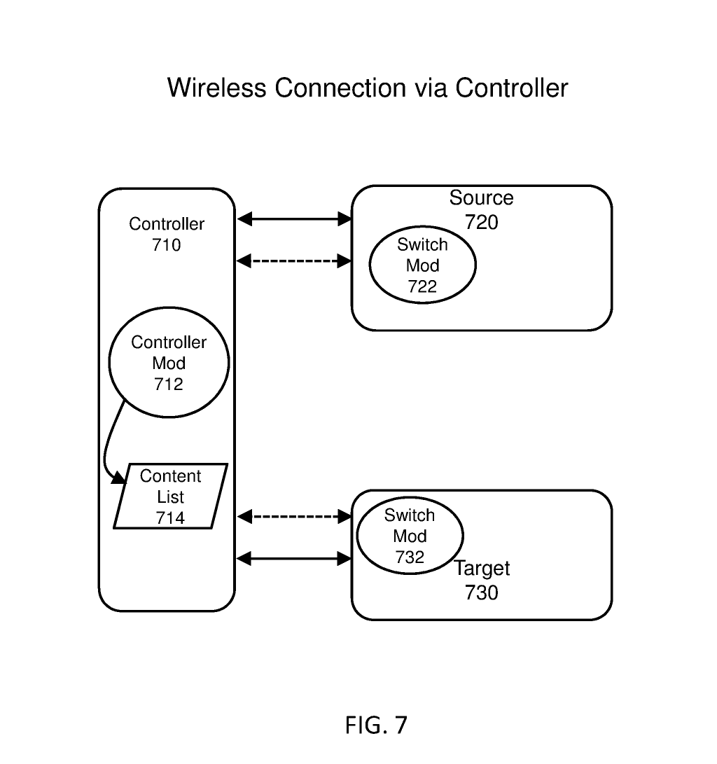

Referring to FIG. 7, according to a second example embodiment, a system for rapid transfer of content files from a source user device 720 to a target user device 730, includes a controller module 712 employed by or installed to a controller device 710, a source switch module 722 employed by or installed to a source user device 720 and a target switch module 732 employed by or installed to a target user device 730. In FIG. 7, solid-line arrows reflect wired connections while broken-line arrows reflect wireless connections.

An example controller module 712 is configured to establish a wired connection with source user device 720 and with target user device 730. With the wired connection established, a source switch module 722 may be downloaded from controller 710 to source user device 720 and a target switch module 732 may be downloaded from controller 710 to target user device 730. Controller module 712 is configured to exchange wireless connectivity credentials with source user device 720 and target user device 730 over the wired connection. Any data or content transmitted over the wired connection may be transmitted through the controller or, in an example, may be transmitted in such a way as to bypass the controller or active components thereof.

Using the exchanged wireless connectivity credentials, controller module 712 is configured to establish a wireless connection between source user device 720 and controller device 710 and between target user device 730 and controller 710. Controller module 712 is configured to create a content list 714 reflecting content file identities and corresponding transfer status. Over the wired connection, content files (for example, content files 236 of FIG. 2) are transferred from source user device 720, through controller device 710 to target user device 730. Over the wireless connection, the content files are transferred from source user device 720, through controller device 710 to target user device 730.

Controller device 710 is further configured to manage transfer policy in accordance with file identities and corresponding transfer status and update content list 714 with content file transfer status. For example, controller module 722 is further configured to route content files to the wireless connection or the wired connection in accordance with data pertaining to the performance of content transfers by each of the wireless connection and the wired connection. As such, content files may be routed to the wireless connection when the wireless connection is performing better than the wired connection or to the wired connection when the wired connection is performing better than the wireless connection.

As with the example of FIG. 5, transfer of content files from source user device 720 to control module 712 over the wireless connection to target user device 730 may be performed while transferring content files from source user device 720 to controller device 710 over the wired connection to target user device 730.

An example source switch module 722 is configured to establish the wired connection with controller device 710 in cooperation with controller module 712 and, over the wired connection, exchange wireless connectivity credentials with controller device 710. Using the exchanged wireless connectivity credentials, source switch module 722 is configured to facilitate establishing the wireless connection between source user device 720 and controller device 710. With both connections established, source switch module 712 may transfer content files to target user device 730 through controller device 710 over the wired connection and transfer content files to target user device 730 through controller device 710 over the wireless connection.

An example target switch module 732 is configured to establish the wired connection with controller device 710 (control machine) in cooperation with controller device 710 and, over the wired connection, share wireless connectivity credentials with controller device 710. Using the shared wireless connectivity credentials, target switch module 732 is configured to establish the wireless connection with source user device 720. With both connections established, target switch module 732 may receive content files (such as content files 336, FIG. 3) from source user device 720 through controller device 710 over the wired connection and through controller device 710 from source user device 720 over the wireless connection.

In some examples, source switch module 722 and target switch module 732 can be instances of the same module. Furthermore, features, responsibilities and/or capabilities of one of controller module 712 and switch modules 722 and 732 can be exchanged between the modules.

FIG. 7 is merely an example, which should not unduly limit the scope of the claims herein. It is to be understood that the specific designation for the source user device and target data processing units is provided as an example and is not to be construed as limiting the data processing units to specific numbers, types, or arrangements of modules and/or components of the data processing units. Furthermore, the specific designation for the controller is provided as an example and is not to be construed as limiting the controller to specific numbers, types, or arrangements of modules and/or components. A person skilled in the art will recognize many variations, alternatives, and modifications of embodiments of the present disclosure.

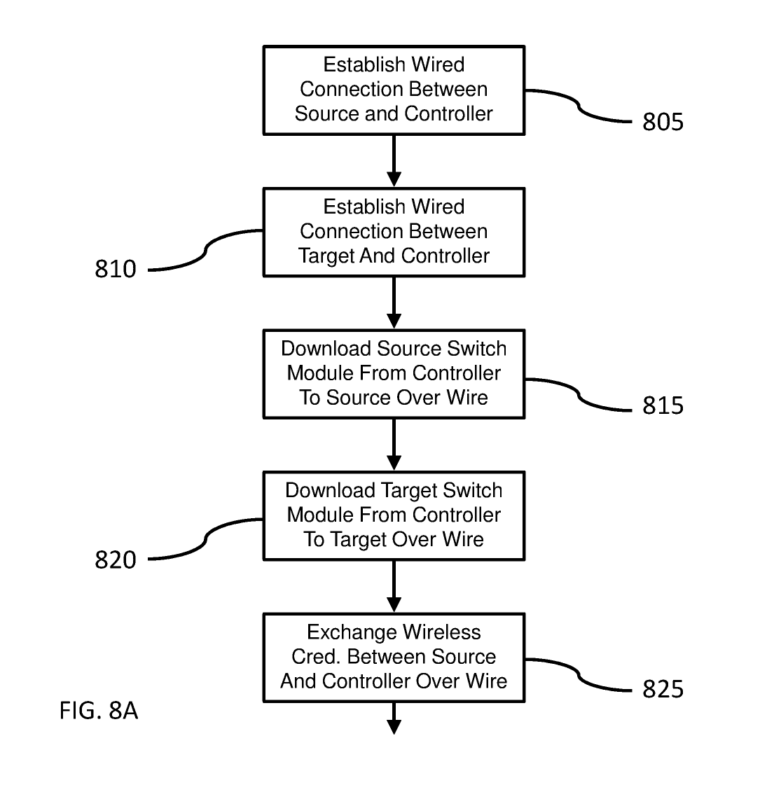

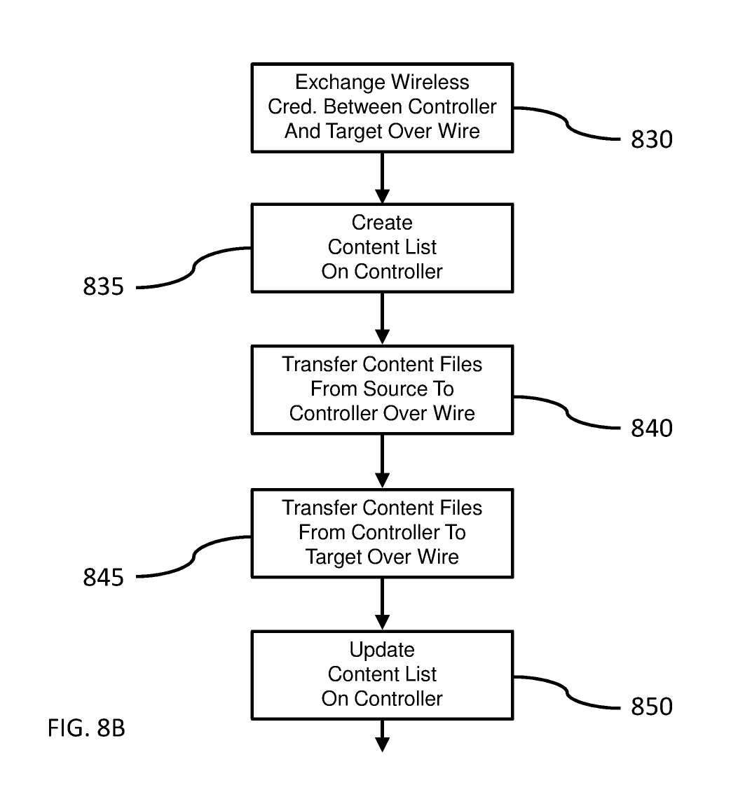

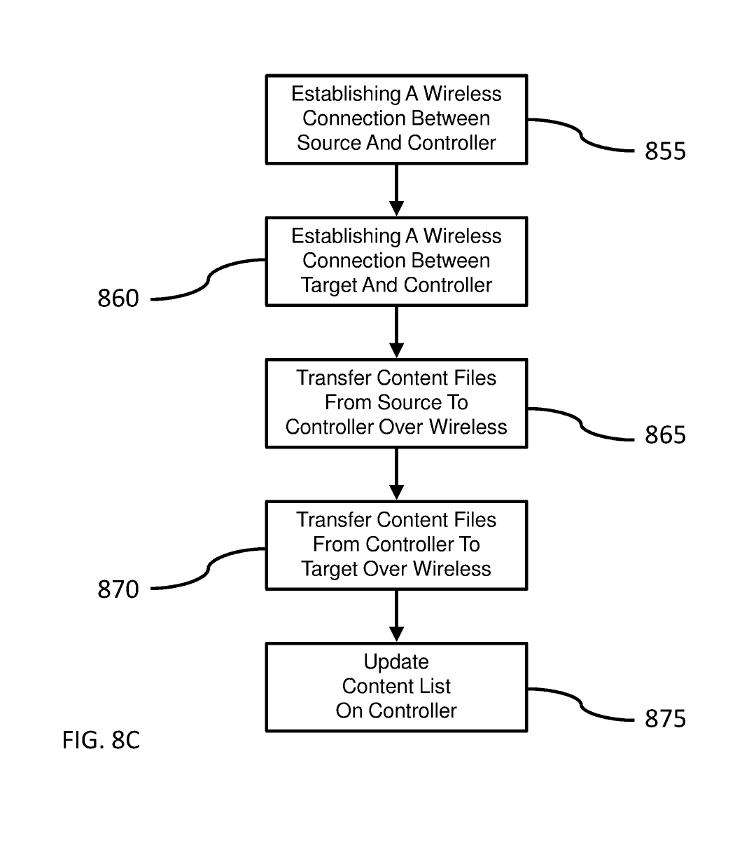

FIGS. 8A-8C illustrate actions of a second example method for rapid content transfer from a source to a target, in accordance with an embodiment of the present disclosure. The method is depicted as a collection of actions in a logical flow diagram, which represents an example sequence of actions that may be implemented in hardware, software, or a combination thereof, as depicted by way of example in FIG. 7.

A wired connection is established between a source user device and a controller at 805 and between a target user device and the controller at 810. A source switch module may be downloaded from the controller to the source user device over the wired connection at 815 and a target switch module may be downloaded from the controller to the target over the wired connection at 820. Wireless connectivity credentials are exchanged between the controller and the source user device at 825 and between the controller and the target over the wired connection at 830. At 835, a content list is created at the controller reflecting details of the content files including identities, file sizes and types and corresponding transfer status. Content files are transferred over the wired connection, from the source user device, through the controller at 840 to the target user device at 845 and the content list is updated at 850. With the exchanged wireless connectivity credentials, a wireless connection is established between the source user device and the controller at 855 and between the target user device and the controller at 860. Content files are transferred over the wireless connection from the source user device, through the controller at 865 and on to the target user device at 870. Transfer policy is managed in accordance with file identities and corresponding transfer status and the content list is updated with content file transfer status at 875.

Transferring the content files from the source user device, through the controller to the target user device over the wireless connection is performed while transferring the content files from the source user device, through the controller to the target user device over the wired connection.

In various embodiments, the wireless transfer of content files can begin automatically or with authorization from the content owner (source mobile device user). For example, with some mobile device operating systems, download and start-up of an application such as the source switch module via a universal serial bus requires the device be manually placed into a developer mode via a user interface of the mobile device. In these scenarios, manual selection of a “wireless boost” to the content file transfer may be enabled rather than automatic start-up.

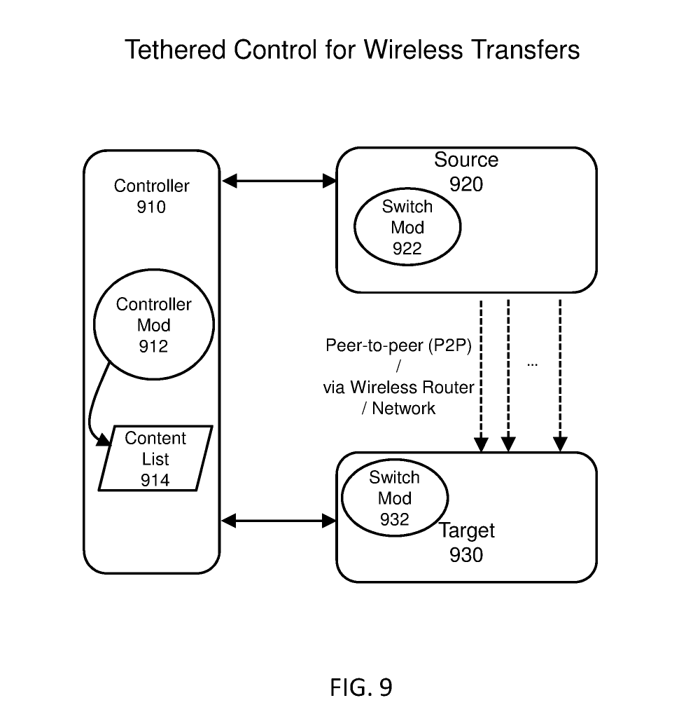

Referring to FIG. 9, according to a third example embodiment employing a wireless boost, a system for rapid transfer of content files from a source user device 920 to a target user device 930, includes a controller module 912 employed by or installed to a controller device 910, a source switch module 922 employed by or installed to a source user device 920 and a target switch module 932 employed by a target user device 930. In FIG. 9, solid-line arrows reflect wired connections while broken-line arrows reflect wireless connections.

An example controller module 912 is configured to establish a wired connection with source user device 920 and a wired connection with target user device 930. A source switch module 922 may be downloaded from controller device 910 to source user device 920 and a target switch module 932 may be downloaded from controller device 910 to target user device 930.

The example controller module 912 is also configured to transfer the content files from source user device 920, through the controller, to target user device 930 over the wired connection. and manage transfer policy in accordance with file identities and corresponding transfer status. Controller module 912 creates and updates content list 914 with content file transfer status. Any data or content transmitted over the wired connection may be transmitted through the controller or, in an example, may be transmitted in such a way as to bypass the controller or active components thereof.

An example source switch module 922 is configured to cooperate with controller module 912 to establish the wired connection with controller device 910.

An example target switch module 932 is configured to establish the wired connection with controller device 910 (control machine) in cooperation with controller module 912.

According to a wireless boost service, a transfer policy engine of controller module 912 monitors transfer activity. When the size of data to be transferred warrants, wireless boost could be suggested. A mobile device user may then be guided to perform manual actions in source user device 920 and/or target user device 930 in order to enable source/target switch module (922/932) download and start-up. With the source/target switch modules 922 and 932 downloaded and running, the system can take full advantage of extra bandwidth offered by wireless connectivity.

As such, controller module 912 is further configured to share wireless connectivity credentials between source user device 920 and target user device 930 through controller device 910 over the wired connection.

Over the wired connection, source switch module 922 shares wireless connectivity credentials with target switch module 932.

Using the shared wireless connectivity credentials source switch 922 may be configured to establish the wireless connection with target user device 930 and to transfer files to target user device directly over the wireless connection.

Using the shared wireless connectivity credentials, target switch module 932 is also configured to establish the wireless connection with source user device 920 and receive content files from source user device 920 directly over the wireless connection.

In some examples, source switch module 922 and target switch module 932 can be instances of the same module. Furthermore, features, responsibilities and/or capabilities of one of controller module 912 and the switch modules 922 or 932 can be exchanged between the modules.

In some examples, tasks or responsibilities of source switch module 922 and target switch module 932 may be provided by one or more operating systems of the source and target user devices 920 and/or 930. For example, media transfer protocol and mass storage class services offered by operating systems may perform one or more transfer actions.

As disclosed above, the presently disclosed systems and methods may be implemented, at least in part, by software in the form of computer-executable instructions. When executed on processors of the controller, the source data processing device and/or the target data processing device the software product is configured to provide a rapid content transfer service.

FIG. 9 is merely an example, which should not unduly limit the scope of the claims herein. It is to be understood that the specific designation for the source user device and target data processing units is provided as an example and is not to be construed as limiting the data processing units to specific numbers, types, or arrangements of modules and/or components of the data processing units. Furthermore, the specific designation for the controller is provided as an example and is not to be construed as limiting the controller to specific numbers, types, or arrangements of modules and/or components. A person skilled in the art will recognize many variations, alternatives, and modifications of embodiments of the present disclosure.

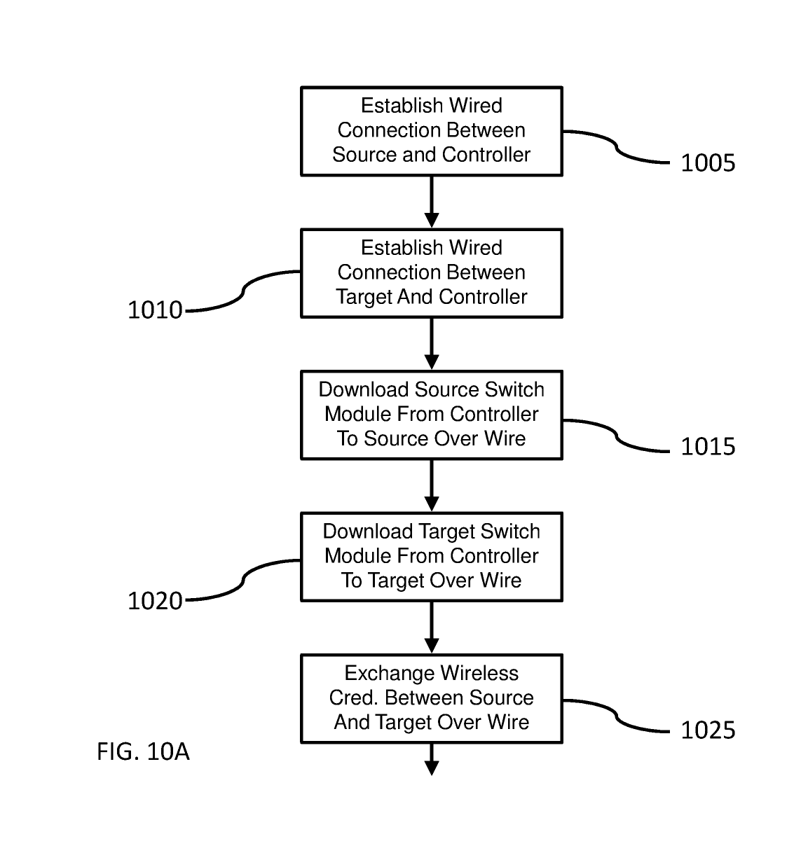

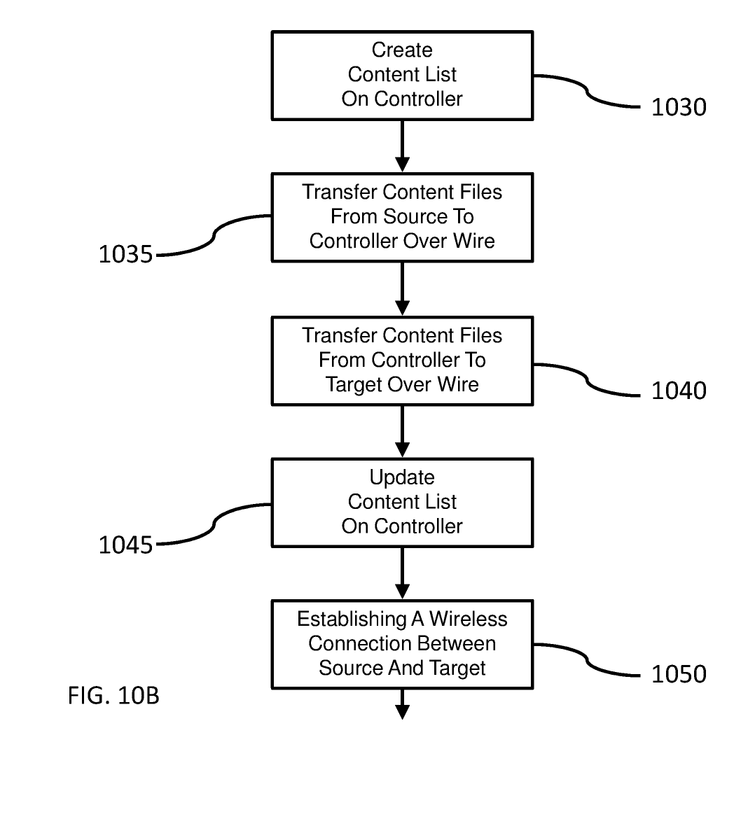

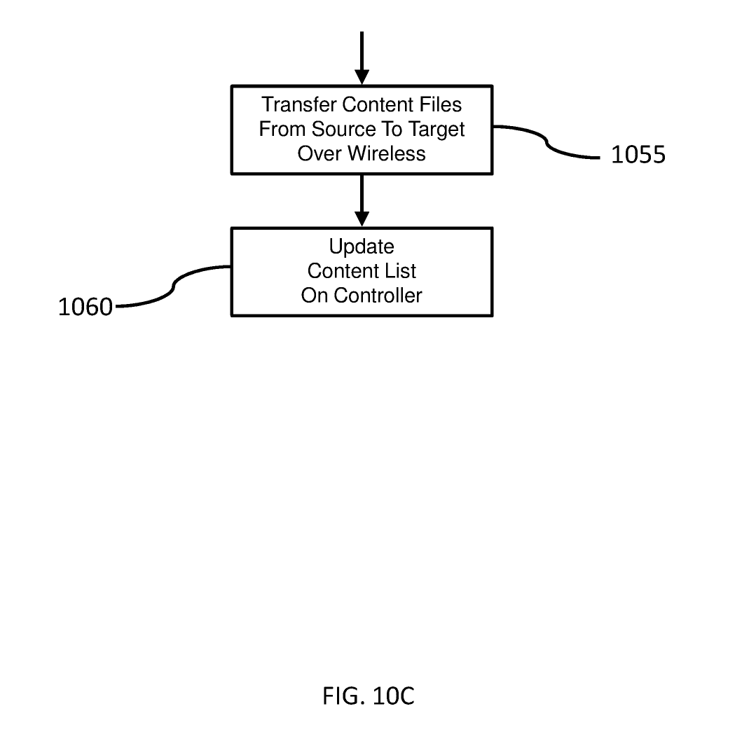

FIGS. 10A-10C illustrate actions of a third example method for rapid content transfer from a source to a target, in accordance with an embodiment of the present disclosure. The method is depicted as a collection of actions in a logical flow diagram, which represents an example sequence of actions that may be implemented in hardware, software, or a combination thereof , as depicted by way of example in FIG. 9.

A wired connection is established between a source user device and a controller at 1005 and between the target user device and the controller 1010 At 1030, a content list is created at the controller reflecting details of the content files including identities, file sizes and types and corresponding transfer status. The content files are transferred over the wired connection, from the source user device, through the controller at 1035 to the target user device at 1040. The content list is updated with content file transfer status at 1045.

Transfer policy is managed in accordance with file identities and corresponding transfer status. The content list is updated with content file transfer status. According to a wireless boost service as described by way of example with reference to FIG. 9, a transfer policy engine of a controller module may monitor transfer activity and, when the size of data to be transferred warrants, wireless boost could be suggested. A mobile device user may then be guided to perform manual actions in a source user device and/or a target user device in order to enable source/target switch module (download and start-up. With the source/target switch modules downloaded and running, the system can take full advantage of extra bandwidth offered by wireless connectivity.

A source switch module may be downloaded from the controller to the source user device at 1015 and a target switch module may be downloaded from the controller to the target user device at 1020.

Wireless connectivity credentials are shared or exchanged between the source user device and the target through the controller over the wired connection at 1025. With the shared wireless connectivity credentials, a wireless connection is established between the source user device and the target user device at 1050 and content files are transferred to the target user device directly over the wireless connection at 1055. The wireless connection may be used exclusively for content file transfer with all control tasks and data transferred through wired connections. At 1060, the content list is updated on the controller.

As with the method of FIG. 6, transferring the content files to the target user device over the direct wireless connection is performed while transferring the content files from the source user device, through the controller to the target user device over the wired connection.

The actions described above are only illustrative and other alternatives can also be provided where one or more actions are added, one or more actions are removed, or one or more actions are provided in a different sequence without departing from the scope of the claims herein.

Embodiments of the present disclosure further provide one or more computer program products that include a non-transitory or non-transient computer-readable storage medium storing computer-executable code for rapid content transfer. The code, when executed, is configured to perform the actions of the example methods as described in conjunction with FIGS. 6, 8 & 10. As actions of the disclosed methods may be provided in different sequences, so the computer-executable code may be configured to provide a service having a different sequence of actions from those illustrated in FIGS. 6, 8 & 10. In some examples, the code may be downloaded from a software application store, for example, from an “App store”, to a data processing unit.

A non-transitory computer-readable medium has stored thereon computer readable instructions configured to cause one or more computing devices to rapidly transfer content files from a source to a target. The instructions cause transmission of wireless connectivity credentials of a source user device to the target through a controller over a wired connection and receipt of wireless connectivity credentials from the target through the controller over the wired connection. The instructions further cause the content files to be transferred through the controller to the target over the wired connection.

According to the instructions, one or more computing devices such as a source user device and/or a target user device establish a direct wireless connection with the target user device using the exchanged wireless connectivity credentials of the target and source user devices. With the direct wireless connection established, the content files are transferred to the target user device over the direct wireless connection.

The computer readable instructions may be further configured to cause one or more computers to create a content list reflecting content file identities and corresponding transfer status. The computer readable instructions are further configured to cause one or more computing devices to collect and store data pertaining to the performance of content transfers.

Transfer policy is managed in accordance with file identities and corresponding transfer status. In an example, content files are routed to the wireless connection or the wired connection in accordance with data pertaining to the performance of content transfers by each of the wireless connection and the wired connection. As such, content files may be routed to the wireless connection when the wireless connection is performing better than the wired connection or to the wired connection when the wired connection is performing better than the wireless connection.

In an example, the computer readable instructions are further configured to cause one or more computers to present a user interface to a display. The user interface may include icons/features representative of transfer process status and/or controls for the transfer process in accordance with the computer readable instructions.

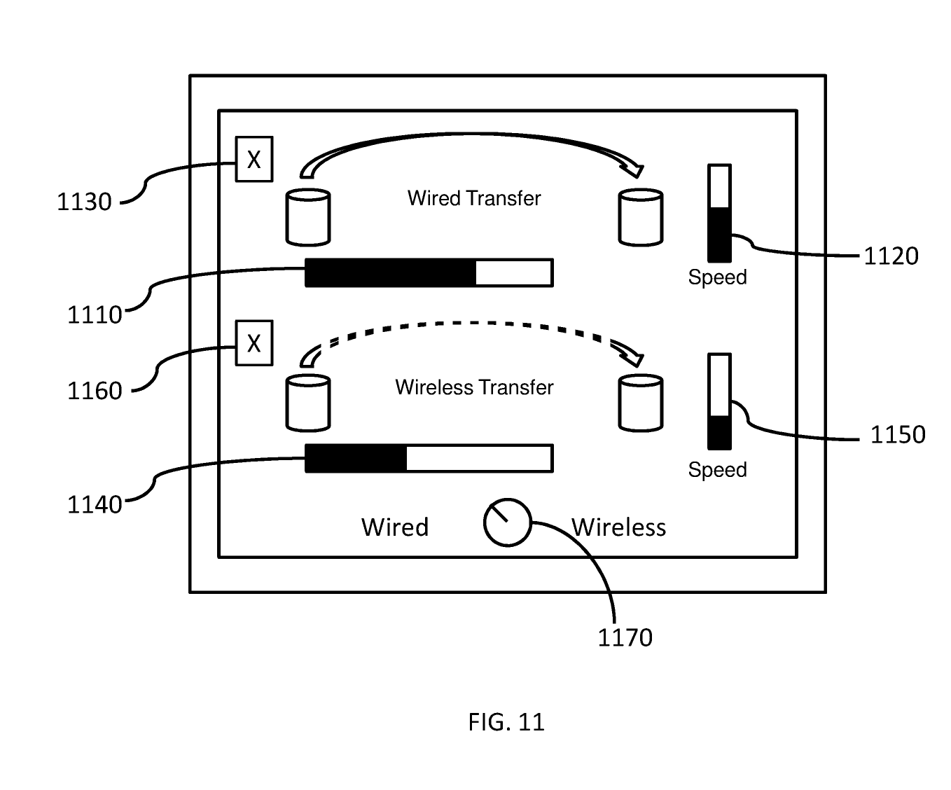

FIG. 11 illustrates an example user interface which may be presented to a display of a controller device, a source user device, a target user device or any combination of these in accordance with a controller module, a source switch module, a target switch module or any combination of these. A transfer status bar 1110 shows the progress of content file transfer by wired connection, a speedometer 1120 shows the transfer speed of the wired connection and a cancel/stop button 1130 enables a user to cancel or stop transfer of content files over the wired connection. A transfer status bar 1140 shows the progress of content file transfer by wireless connection, a speedometer 1150 shows the transfer speed of the wireless connection and a cancel/stop button 1160 enables a user to cancel or stop transfer of content files over the wireless connection. A virtual knob 1170 enables a user to emphasize transfer by either wired or wireless connection. In examples in which assignment of transfer responsibilities is performed automatically by one or more of the controller module, the source switch module or the target switch module, virtual know 1170 may only display to the user how the transfers are being weighted.

Embodiments of the present disclosure are susceptible to being used for various purposes, including, though not limited to, enabling users to transfer content from a source mobile device to a target mobile device.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A system for rapid transfer of content files from a source to a target, comprising:
a controller module;
a target switch module; and
a source switch module configured to:
transmit wireless connectivity credentials to the target through a controller over a wired connection;
receive wireless connectivity credentials from the target through the controller over the wired connection;
transfer the content files through the controller to the target over the wired connection; and
establish a direct wireless connection with the target using the exchanged wireless connectivity credentials; and
transfer files to the target over the direct wireless connection.

2. The system as set forth in claim 1, wherein the source switch module is further configured to:
create a content list reflecting content file identities and corresponding transfer status; and
manage transfer policy in accordance with file identities and corresponding transfer status.

3. The system as set forth in claim 2, wherein the source switch module is further configured to store data pertaining to performance of content transfers.

4. The system as set forth in claim 3, wherein, in order to manage transfer policy, the source switch module is further configured to route content files to the wireless connection or the wired connection in accordance with data pertaining to the performance of content transfers by each of the wireless connection and the wired connection.

5. The system as set forth in claim 1, wherein the source switch module is further configured to present a user interface to a display.

6. The system as set forth in claim 5, wherein the user interface includes icons/features representative of transfer process status.

7. The system as set forth in claim 1, wherein the system is further configured to transfer the content files to the target over the direct wireless connection during the transfer of content files from the source, through the controller to the target over the wired connection.

8. A method for rapid transfer of content files from a source to a target, comprising:
transmitting wireless connectivity credentials to the target through a controller over a wired connection;
receiving wireless connectivity credentials from the target through the controller over the wired connection;
transferring the content files through the controller to the target over the wired connection;
establishing a direct wireless connection with the target with the exchanged wireless connectivity credentials; and
transferring the content files to the target over the direct wireless connection.

9. The method as set forth in claim 8, further comprising:
creating a content list reflecting content file identities and corresponding transfer status; and
managing transfer policy in accordance with file identities and corresponding transfer status.

10. The method as set forth in claim 9, further comprising storing data pertaining to the performance of content transfers.

11. The method as set forth in claim 10, wherein, managing transfer policy further comprises to routing content files to the wireless connection or the wired connection in accordance with data pertaining to the performance of content transfers by each of the wireless connection and the wired connection.

12. The method as set forth in claim 8, further comprising presenting a user interface to a display.

13. The method as set forth in claim 12, wherein presenting the user interface to the display further comprises presenting icons/features representative of transfer process status.

14. The method as set forth in claim 8, wherein the transferring the content files to the target over the direct wireless connection is performed during transferring the content files from the source, through the controller to the target over the wired connection.

15. A non-transitory computer-readable medium having stored thereon computer readable instructions configured to cause one or more computers to:
transmit wireless connectivity credentials to the target through a controller over a wired connection;
receive wireless connectivity credentials from the target through the controller over the wired connection;
transfer the content files through the controller to the target over the wired connection;
establish a direct wireless connection with the target with the exchanged wireless connectivity credentials; and
transfer the content files to the target over the direct wireless connection.

16. The non-transitory computer-readable medium as set forth in claim 15, wherein the computer readable instructions are further configured to cause one or more computers to:
create a content list reflecting content file identities and corresponding transfer status; and
manage transfer policy in accordance with file identities and corresponding transfer status.

17. The non-transitory computer-readable medium as set forth in claim 16, wherein the computer readable instructions are further configured to cause one or more computers to: store data pertaining to the performance of content transfers.

18. The non-transitory computer-readable medium as set forth in claim 17, wherein, in order to manage transfer policy, the computer readable instructions are further configured to cause one or more computers to: route content files to the wireless connection or the wired connection in accordance with data pertaining to the performance of content transfers by each of the wireless connection and the wired connection.

19. The non-transitory computer-readable medium as set forth in claim 15, wherein the computer readable instructions are further configured to cause one or more computers to: present a user interface to a display.

20. The non-transitory computer-readable medium as set forth in claim 19, wherein the computer readable instructions are further configured to cause one or more computers to: present icons/features representative of transfer process status.

21. The non-transitory computer-readable medium as set forth in claim 15, wherein the computer readable instructions are further configured to cause one or more computers to transfer the content files to the target over the direct wireless connection during the transfer of the content files from the source, through the controller to the target over the wired connection.

22. A system for rapid transfer of content files from a source to a target, comprising:
a controller module configured to:
exchange wireless connectivity credentials with the source over a wired connection;
exchange wireless connectivity credentials with the target over a wired connection;
establish a wireless connection between the source and a controller using the exchanged wireless connectivity credentials;
establish a wireless connection between the target and the controller using the exchanged wireless connectivity credentials;
transfer, over the wired connection, the content files from the source, through the controller to the target;
a source switch module configured to:
transfer, over the wireless connection using the exchanged wireless connectivity credentials, the content files from the source, to the control machine; and
a target switch module configured to:
receive files at the target through the controller over the wireless connection.
